(19) United States
(12) Patent Application Publication
(10) Pub. No.: US 2025/0327964 A1
(43) Pub. Date: Oct. 23, 2025

(54) ELECTRONIC DEVICE AND LIGHTGUIDE ASSEMBLY THEREOF

(71) Applicant: Wistron Corporation, New Taipei City (TW)

(72) Inventors: Hsin-Hung CHOU, New Taipei City (TW); Cheng-Hsuan LIN, New Taipei City (TW)

(21) Appl. No.: 18/788,762

(22) Filed: Jul. 30, 2024

(30) Foreign Application Priority Data
Apr. 17, 2024 (TW) 113114373

(51) Int. Cl. F21V 8/00; H04M 1/22

(52) U.S. Cl. CPC G02B 6/0043; G02B 6/0068; H04M 1/22

(57) ABSTRACT

An electronic device includes a housing having a strip-shaped light-transmissive portion and a lightguide assembly including a base plate having a connection region, a first extension region, and a second extension region, a lightguide member disposed on the base plate, and light-emitting members. The lightguide member corresponds to the strip-shaped light-transmissive portion and has a connection portion, a first extension portion, and a second extension portion. Reflective microstructures are distributed in the first extension region, the second extension region, and the connection region with a first to a third average density, respectively. The third average density is greater than the first and the second average densities. The light-emitting members are adjacent to the connection portion. An emitting direction of a portion of the light-emitting members is toward the first extension region, and an emitting direction of another portion of the light-emitting members is toward the second extension region.

### CROSS-REFERENCE TO RELATED APPLICATION

This non-provisional application claims priority under 35 U.S.C. § 119 (a) to patent application No. 113114373 filed in Taiwan, R.O.C. on Apr. 17, 2024, the entire contents of which are hereby incorporated by reference.

### BACKGROUND

### Technical Field

The instant disclosure relates to an electronic device, particularly to an electronic device including a lightguide assembly.

### Related Art

An electronic device which has a lightguide assembly and is known to the inventor is capable of exhibiting a visual effect of equal brightness within the range of a lightguide pillar of the lightguide assembly.

In order to exhibit a gradually brighter or gradually dimmer visual effect along the lightguide pillar, an electronic device which has a lightguide assembly and is known to the inventor implements multiple vertical LEDs at different positions and controls the light-emitting power of each of the LEDs. However, this solution generates bright spots at positions corresponding to the LEDs, and therefore the visual effect is not uniform.

In order to address the issue of non-uniform visual effect, one solution known to the inventor is to add diffusion agent into the lightguide pillar. However, this solution results in deteriorated light-emitting power and waste of electricity.

### SUMMARY

To address the above issues, some embodiments of the instant disclosure provide an electronic device including a housing, a circuit board, and a lightguide assembly. The housing has a strip-shaped light-transmissive portion. The circuit board is disposed in the housing. The lightguide assembly includes a base plate, a lightguide member, and a plurality of light-emitting members. The base plate has a plurality of reflective microstructures. The lightguide member is disposed on the base plate and corresponds to the strip-shaped light-transmissive portion. The lightguide member has a connection portion, a first extension portion, and a second extension portion. The connection portion is connected to the first extension portion at a first connecting portion and connected to the second extension portion at a second connecting portion. The base plate has a connection region, a first extension region, and a second extension region. The connection region, the first extension region, and the second extension region respectively correspond to the connection portion, the first extension portion, and the second extension portion. The reflective microstructures are distributed in the connection region with a third average density. The reflective microstructures are distributed over the first extension region with a first average density. The reflective microstructures are distributed in the second extension region with a second average density. The third average density is greater than the first average density. The third average density is greater than the second average density. The light-emitting members are electrically connected to the circuit board and adjacent to the connection portion. An emitting direction of a portion of the light-emitting members is toward the first extension region, and an emitting direction of another portion of the light-emitting members is toward the second extension region.

Some embodiments of the instant disclosure provide a lightguide assembly including a base plate, a lightguide member, and a plurality of light-emitting members. The base plate has a plurality of reflective microstructures. The lightguide member is disposed on the base plate and has a connection portion, a first extension portion, and a second extension portion. The connection portion is connected to the first extension portion at a first connecting portion and connected to the second extension portion at a second connecting portion. The base plate has a connection region, a first extension region, and a second extension region. The connection region, the first extension region, and the second extension region respectively correspond to the connection portion, the first extension portion, and the second extension portion. The reflective microstructures are distributed in the connection region with a third average density. The reflective microstructures are distributed over the first extension region with a first average density. The reflective microstructures are distributed in the second extension region with a second average density. The third average density is greater than the first average density. The third average density is greater than the second average density. The light-emitting members are adjacent to the connection portion. An emitting direction of a portion of the light-emitting members is toward the first extension region, and an emitting direction of another portion of the light-emitting members is toward the second extension region.

As above, the lightguide assembly provided by one or some embodiments of the instant disclosure uses fewer side emitting light sources, and the light sources are arranged outside of the light-exiting area. One or some embodiments of the instant disclosure utilizes the distribution densities of the reflective microstructures to achieve a uniform and brighter (such as gradually brighter) or dimmer (such as gradually dimmer) visual effect. Besides, the lightguide assembly of one or some embodiments of the instant disclosure does not contain diffusion agent, and therefore the light loss is less, and consumption of electrical power can be reduced.

### BRIEF DESCRIPTION OF THE DRAWINGS

The instant disclosure will become more fully understood from the detailed description given herein below for illustration only, and therefore not limitative of the instant disclosure, wherein:

FIG. 1 illustrates a perspective view of an electronic device according to an embodiment of the instant disclosure;

FIG. 2 illustrates an exploded view of an electronic device according to an embodiment of the instant disclosure;

FIG. 3 illustrates a perspective view of a base plate and a lightguide member of a lightguide assembly according to an embodiment of the instant disclosure, showing a projection region formed in the interior of the base plate by the lightguide member;

FIG. 4 illustrates a top view of a base plate and a lightguide member of a lightguide assembly according to an embodiment of the instant disclosure;

FIG. 5 illustrates a cross-sectional view along line 5-5 shown in FIG. 4, wherein the cross-section view also illustrates a cross-sectional view of a circuit board, a light-blocking sheet, and a light-reflective sheet at the same location and shows light-exiting paths of a first light-emitting member and a third light-emitting member;

FIG. 6 illustrates a cross-sectional view along line 6-6 shown in FIG. 4, wherein the cross-sectional view also illustrates a cross-sectional view of a circuit board, a light-blocking sheet, and a light-reflective sheet at the same location and shows a light-exiting path of a first light-emitting member;

FIG. 7 illustrates a bottom view of a base plate of a lightguide assembly according to an embodiment of the instant disclosure, showing a distribution of reflective microstructures;

FIG. 8 illustrates an enlarged partial view of an oval region denoted with C shown in FIG. 7, showing a distribution of reflective microstructures in a connection region;

FIG. 9 illustrates an enlarged partial view of an oval region denoted with D shown in FIG. 7, showing a distribution of reflective microstructures in a first extension region;

FIG. 10 illustrates a top view of a base plate and a lightguide member of a lightguide assembly according to an embodiment of the instant disclosure; and

FIG. 11 illustrates a top view of a base plate and a lightguide member of a lightguide assembly according to an embodiment of the instant disclosure.

### DETAILED DESCRIPTION

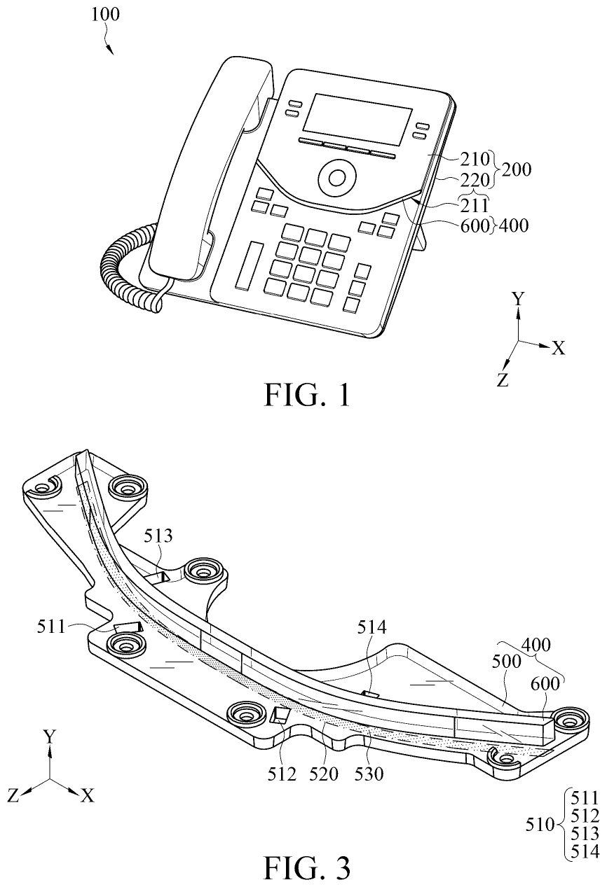

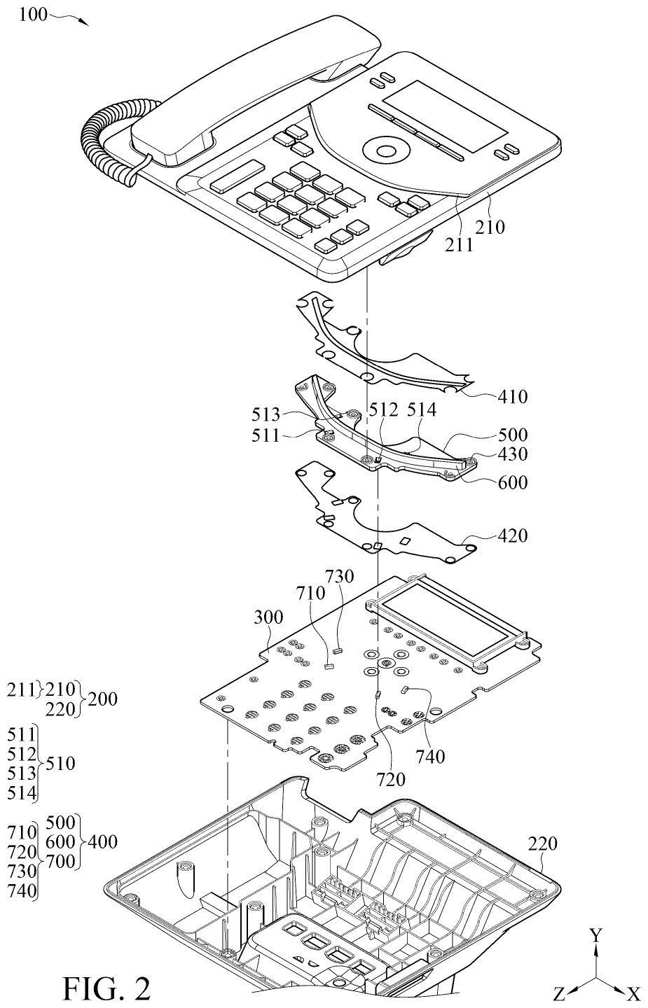

Please refer to FIG. 1 and FIG. 2. FIG. 1 illustrates a perspective view of an electronic device 100 according to an embodiment of the instant disclosure. FIG. 2 illustrates an exploded view of the electronic device 100 according to an embodiment of the instant disclosure. The electronic device 100 of some embodiments of the instant disclosure includes a housing 200, a circuit board 300, and a lightguide assembly 400. In this embodiment, the electronic device 100 is a telephone, but in other embodiments, the electronic device 100 may be various different devices, such as a display, a printer, an air conditioner, or the like.

The housing 200 has a strip-shaped light-transmissive portion 211. In some embodiments, the housing 200 includes an upper housing 210 and a lower housing 220, and the strip-shaped light-transmissive portion 211 is on the upper housing 210, but the instant disclosure is not limited thereto. In some embodiments, the strip-shaped light-transmissive portion 211 may be on other positions on the upper housing 210, or the strip-shaped light-transmissive portion 211 may also be on the lower housing 220. The circuit 300 board is in the housing 200 and provides circuit elements for the operation of the electronic device 100 (such as elements related to the functions of a telephone) and light sources of the lightguide assembly 400 (such as light-emitting members 700). In some embodiments, the strip-shaped light-transmissive portion 211 is a strip-shaped slot arranged on the housing 200.

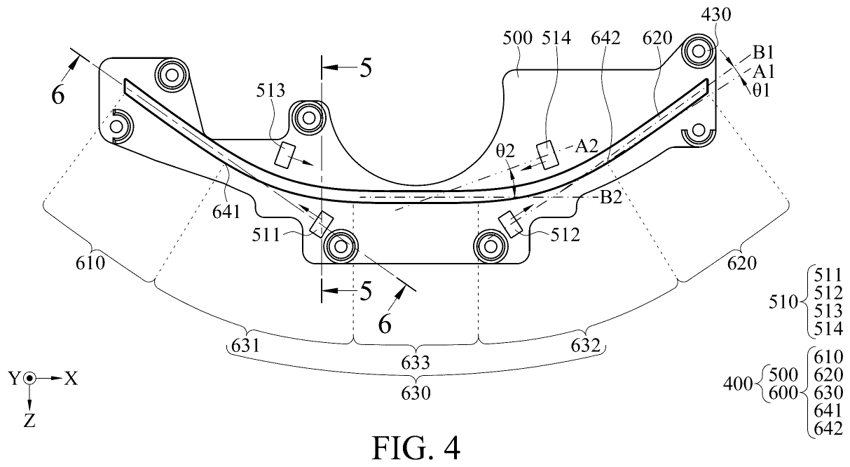

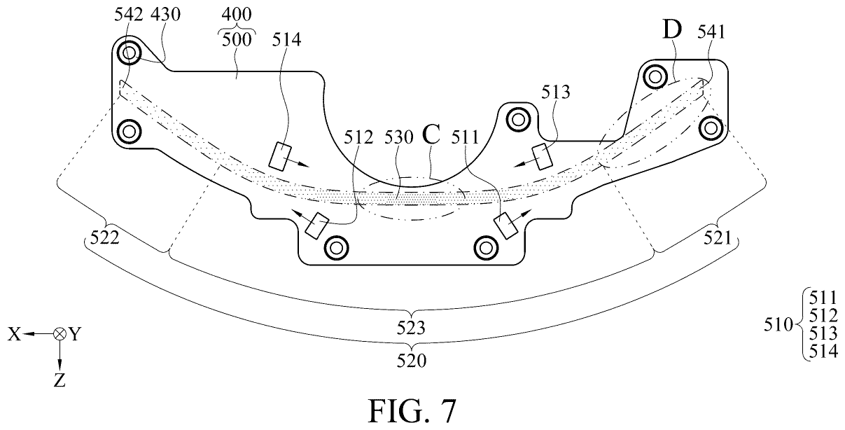

Please refer to FIG. 2 through FIG. 4. FIG. 3 illustrates a perspective view of a base plate 500 and a lightguide member 600 of the lightguide assembly 400 according to an embodiment of the instant disclosure, showing a projection region 520 formed in the interior of the base plate 500 by the lightguide member 600. FIG. 4 illustrates a top view of the base plate 500 and the lightguide member 600 of the lightguide assembly 400 according to an embodiment of the instant disclosure. The lightguide assembly 400 includes the base plate 500, the lightguide member 600, and the light-emitting members 700. The base plate 500 has a plurality of reflective microstructures 530 (as shown in FIG. 7 through FIG. 9). It can be seen in FIG. 2 through FIG. 4 that the base plate 500 has a profile of an irregular shape. This profile is to yield space for the arrangement of other elements of the electronic device 100, and the profile of the base plate 500 is not limited thereto. In some embodiments, as shown in FIG. 2 through FIG. 4, the base plate 500 has one or more fixing members 430. The fixing members 430 may for example be a screw hole for fixing with a screw.

Please refer to FIG. 2 through FIG. 4. The lightguide member 600 is on the base plate 500 and corresponds to the strip-shaped light-transmissive portion 211. The lightguide member 600 has a connection portion 630, a first extension portion 610, and a second extension portion 620. The connection portion 630 is connected to the first extension portion 610 at a first connecting portion 641 and connected to the second extension portion 620 at a second connecting portion 642. The lightguide member 600 forms the projection 520 in the base plate 500. Specifically, in some embodiments, the lightguide member 600 has the first extension portion 610, the connection portion 630, and the second extension portion 620 which are sequentially connected to one another. In some embodiments, the lightguide member 600 is a wall perpendicular to the base plate 500, and the projection region 520 is a region where the lightguide member 600 is projected onto a surface of the base plate 500 (as shown in FIG. 3, where the base plate 500 and the lightguide member 600 are presented transparently in order to present the projection region 520 in the base plate 500). In some embodiments, the lightguide member 600 and the base plate 500 are integrally formed as a one-piece member. In some embodiments, a material of the lightguide member 600 and the base plate 500 is fully transparent PMMA (polymethyl methacrylate). In some embodiments, the strip-shaped light-transmissive portion 211 is a strip-shaped slot arranged on the housing 200, and the lightguide member 600 is closely embedded in the strip-shaped light-transmissive portion 211.

In some embodiments, the connection region 630 includes a first arc portion 631, a second arc portion 632, and a middle section 633. The first arc portion 631 is connected to the first extension portion 610 at the first connecting portion 641. The second arc portion 632 is connected to the second extension portion 620 at the second connecting portion 642. The middle section 633 is connected between the first arc portion 631 and the second arc portion 632. Specifically, in some embodiments, the connection region 630 includes the first arc portion 631, the middle section 633, and the second arc portion 632 which are sequentially connected to one another. In some embodiments, the middle section 633 exhibits a straight line (as shown in FIG. 4). In some embodiments, a portion of the light-emitting members 700 (such as a first light-emitting member 710 and a third light-emitting member 730) is adjacent to the first arc portion 631, and another portion of the light-emitting members 700 (such as a second light-emitting member 720 and a fourth light-emitting member 740) is adjacent to the second arc portion 632. Therefore, the lightguide member 600 can exhibit a smile curve when viewed from the top.

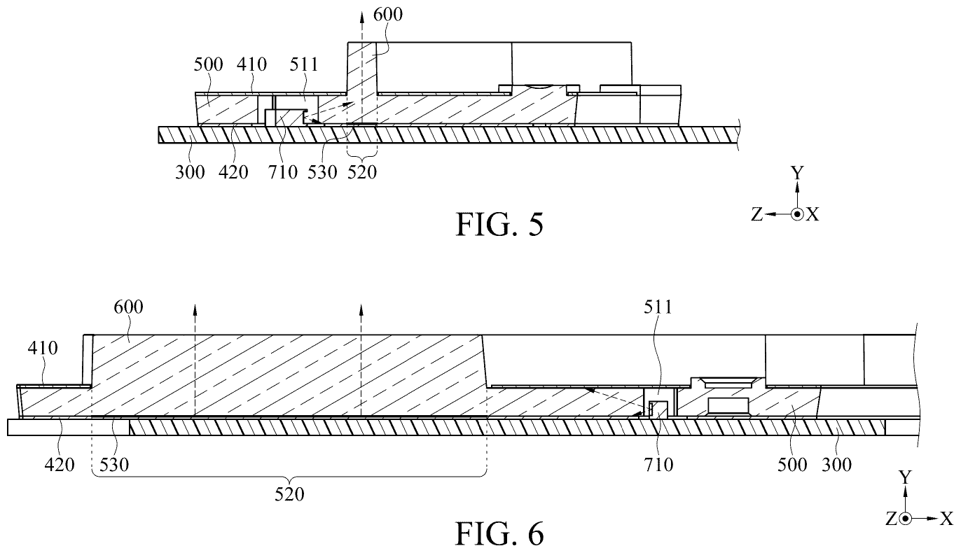

Please refer to FIG. 5 through FIG. 7. FIG. 5 illustrates a cross-sectional view along line 5-5 shown in FIG. 4, wherein the cross-section view also illustrates a cross-section view of the circuit board 300, a light-blocking sheet 410, and a light-reflective sheet 420 at the same location and shows light-exiting paths of the first light-emitting member 710 and the third light-emitting member 730. FIG. 6 illustrates a cross-sectional view along line 6-6 shown in FIG. 4, wherein the cross-sectional view also illustrates a cross-sectional view of the circuit 300 board, the light-blocking sheet 410, and the light-reflective sheet 420 at the same location and shows a light-exiting path of the first light-emitting member 710. FIG. 7 illustrates a bottom view of the base plate 500 of the lightguide assembly 400 according to an embodiment of the instant disclosure, showing a distribution of the reflective microstructures 530. The reflective microstructures 530 are distributed in the projection region 520. The projection region 520 has a connection region 523, a first extension region 521, and a second extension region 522. The connection region 523, the first extension region 521, and the second extension region 522 respectively correspond to the connection portion 630, the first extension portion 610, and the second extension portion 620. The reflective microstructures 530 are distributed in the connection region 523 with a third average density. The reflective microstructures 530 are distributed in the first extension region 521 with a first average density. The reflective microstructures 530 are distributed in the second extension region 522 with a second average density.

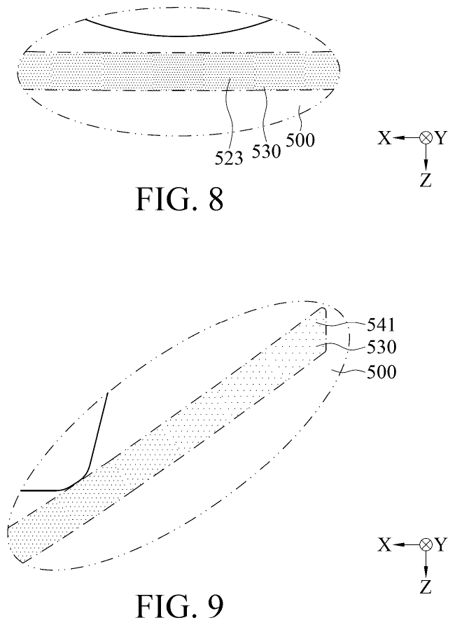

Please refer to FIG. 8 and FIG. 9. FIG. 8 illustrates an enlarged partial view of an oval region denoted with C shown in FIG. 7, showing a distribution of the reflective microstructures 530 in the connection region 523. FIG. 9 illustrates an enlarged partial view of an oval region denoted with D shown in FIG. 7, showing a distribution of reflective microstructures 530 in the first extension region 521. The third average density is greater than the first average density and is greater than the second average density. The function of the reflective microstructures 530 is to guide the light from the light-emitting members 700 in a direction perpendicular to the base plate 500 toward the lightguide member 600. Thus, the light can penetrate to the exterior of the electronic device 100 through the strip-shaped light-transmissive portion 211. Consequently, a user may observe a light strip. Because the third average density is greater than the first average density and the second average density, as compared with the first extension region 521 and the second extension region 522, the connection region 523 can perpendicularly guide more light. Therefore, the light strip viewed by the user exhibits an effect where the middle portion is brighter, and the two sides are dimmer. In some embodiments, the reflective microstructures 530 are formed in the projection region 520 through laser dotting.

In some embodiments, the first average density is an average density with which the reflective microstructures 530 are distributed in the first extension region 521, the first extension region 521 has a free end 541 away from the connection region 523, and a distribution density with which the reflective microstructures 530 are distributed in the first extension region 521 is decreased (such as gradually decreased) from the connection region 523 toward the free end 541 of the first extension region 521. Therefore, the first extension region 610 of the lightguide member 600 exhibits a light emission effect where the brightness is decreased (such as gradually decreased) when viewed from the top. In some embodiments, the second average density is an average density with which the reflective microstructures 530 are distributed in the second extension region 522, the second extension region 522 has a free end 542 away from the connection region 523, and a distribution density with which the reflective microstructures 530 are distributed in the second extension region 522 is decreased (such as gradually decreased) from the connection region 523 toward the free end 542 of the second extension region 522. Therefore, the second extension region 620 of the lightguide member 600 exhibits a light emission effect where the brightness is decreased (such as gradually decreased) when viewed from the top. In some embodiments, the third average density is at least twice the first average density. In some embodiments, the third average density is about 62500 reflective microstructures/cm², and the first average density is about 25000 reflective microstructures/cm². In some embodiments, the first average density is equal to the second average density, but the instant disclosure is not limited thereto. In some embodiments, a depth of the distribution of the reflective microstructures 530 in the base plate 500 is in a range of roughly 6-8 micrometers. Specifically, in some embodiments, this depth is a depth measured from a bottom side (a side adjacent to the circuit board 300) of the base plate 500.

Please refer to FIG. 2 through FIG. 4. The light-emitting members 700 are electrically connected to the circuit board 300 and adjacent to the connection portion 630. In some embodiments, a portion of the light-emitting members 700 is adjacent to the first connecting portion 641, and another portion of the light-emitting members 700 is adjacent to the second connecting portion 642. An emitting direction of a portion of the light-emitting members 700 is toward the first extension region 521, and an emitting direction of another portion of the light-emitting members is toward the second extension region 522. In some embodiments, the light-emitting members 700 are LEDs (light-emitting diodes). In some embodiments, the base plate 500 includes a plurality of light source slots 510. The light source slots 510 are on the base plate 500. Each of the light source slots 510 is adjacent to the connection region 523 and not in the projection region 520. The light-emitting members 700 are respectively in the light source slots 510. Therefore, a primary optical axis of each of the light-emitting members 700 can be roughly parallel to a bottom surface of the base plate 500. Consequently, the light is emitted to the projection region 520, so that the light can be emitted from a top surface of the lightguide member 600 through the reflective microstructures 530 in the projection region 520 (as shown in FIG. 5 and FIG. 6).

Please refer to FIG. 2 through FIG. 4. In some embodiments, the light-emitting members 700 include the first light-emitting member 710, the second light-emitting member 720, the third light-emitting member 730, and the fourth light-emitting member 740, and the light source slots 510 includes a first light source slot 511, a second light source slot 512, a third light source slot 513, and the fourth light source slot 514. As compared with the second light-emitting member 720, the first light-emitting member 710 is nearer the first connecting portion 641 (in other words, in some embodiments, a distance between the first light-emitting member 710 and the first connecting portion 641 is less than a distance between the second light-emitting member 720 and the first connecting portion 641), and the light-emitting direction of the first light-emitting member 710 is toward the first extension region 521, as shown by an arrow extending from the first light source slot 511 shown in FIG. 4. As compared with the second light-emitting member 720, the second light-emitting member 720 is nearer the second connecting portion 642 (in other words, in some embodiments, a distance between the second light-emitting member 720 and the second connecting portion 642 is less than a distance between the first light-emitting member 710 and the second connecting portion 642), and the light-emitting direction of the second light-emitting member 720 is toward the second extension region 522. Specifically, in some embodiments, the third light-emitting member 730 is between the middle section 633 and the first connecting portion 641, and the fourth light-emitting member 740 is between the middle section 633 and the second connecting portion 642. In some embodiments, the first light source slot 511 in which the first light-emitting member 710 is located is adjacent to the first connecting portion 641 and allows the first light-emitting member 710 to face the first extension region 521; the second light source slot 512 in which the second light-emitting member 720 is located is adjacent to the second connecting portion 642 and allows the second light-emitting member 720 to face the second extension region 522; the third light source slot 513 in which the third light-emitting member 730 is located is adjacent to the first connecting portion 641 and allows the third light-emitting member 730 to face the connection region 523; and the fourth light source slot 514 in which the fourth light-emitting member 740 is located is adjacent to the second connecting portion 642 and allows the fourth light-emitting member 740 to face the connection region 523.

As shown in FIG. 4. Specifically, in some embodiments, the first light-emitting member 710 has a first emitting main axis A1 (shown with a two-dot chain line in FIG. 4), the first extension region 521 has a long axis B1 (i.e., an axis formed along the extension direction of the length of the first extension region 521, shown with a chain line in FIG. 4), and an angle θ1 between the first emitting main axis A1 and the long axis B1 is between 0° and 25°. However, this angle θ1 may be adjusted in accordance with emission angles of the light-emitting members 700 which are used and in accordance with a desired visual effect, and the instant disclosure is not limited thereto. In different embodiments, an angular relationship between the second light-emitting member 720 and the second extension region 522 may be the identical or not identical to an angular relationship between the first light-emitting member 710 and the first extension region 521. In some embodiments, the third light-emitting member 730 has a third emitting main axis A2 (shown with a two-dot chain line in FIG. 4), the connection region 523 has a middle section axis B2 (i.e., an axis formed along the extension direction of the length of the middle section 633, shown with a chain line in FIG. 4), and an angle θ2 between the third emitting main axis A2 and the middle section axis B2 is between 15° and 30°. Therefore, the connection region 523 is provided with light sources by two light-emitting members 700 at the same time, and thus, as compared with the first extension region 521 and the second extension region 522, the connection region 523 can receive more optical energy. However, this angle θ2 may be adjusted in accordance with emission angles of the light-emitting members 700 which are used and in accordance with a desired visual effect, and the instant disclosure is not limited thereto. In different embodiments, an angular relationship between the fourth light-emitting member 740 and the connection region 523 may be the identical or not identical to an angular relationship between the third light-emitting member 730 and the connection region 523.

In some embodiments, the light-emitting members 700 can perform different light-emitting actions, such as breathing mode, constant mode, blinking mode, color changing, and intensity changing, through the control of the circuit board 300.

Please refer to FIG. 2, FIG. 5, and FIG. 6 again. In some embodiments, the electronic device 100 further includes the light-blocking sheet 410. The light-blocking sheet 410 is between the base plate 500 and the housing 200. The light-blocking sheet 410 has a gap (as shown in FIG. 2). The lightguide member 600 is arranged to pass through the gap 410. In some embodiments, a size of the gap of the light-blocking sheet 410 matches with a size of the lightguide member 600. Specifically, in some embodiments, the light-blocking sheet 410 is between the base plate 500 and the upper housing 210. The light-blocking sheet 410 is closely attached on the upper surface of the base plate 500 (the surface of the base plate 500 on which the lightguide member 600 is) to prevent light from leaking through regions other than the lightguide member 600. Consequently, the appearance of the electronic device 100 can be prevented from exhibiting undesired excessive light. As shown in FIG. 2, because the purpose of the light-blocking sheet 410 is to prevent light from leaking through regions other than the lightguide member 600, a coverage range of the light-blocking sheet 410 is above the upper surface of the base plate 500 and above each of the light source slots 510. Besides, the light-blocking sheet 410 does not cover the lightguide member 600 and the fixing members 430. In some embodiments, a side surface of the lightguide member 600 may also be provided with the light-blocking sheet 410 or has a light-blocking coating to further prevent a side emission of the lightguide member 600.

Please continue to refer to FIG. 2, FIG. 5, and FIG. 6. In some embodiments, the electronic device 100 further includes the light-reflective sheet 420. The light-reflective sheet 420 is between the base plate 500 and the circuit board 300. Specifically, in some embodiments, the light-reflective sheet 420 is closely attached on the lower surface of the base plate 500 (the surface of the base plate 500 opposite to the surface on which the lightguide member 600 is) to reflect a light emitted downward to the top. Therefore, upward emission can be enhanced, and thus the optical energy of each of the light-emitting members 700 can be more efficiently used. In some embodiments, as shown in FIG. 2, because the purpose of the light-reflective sheet 420 is to reflect the light emitted downward to the top, the light-reflective sheet 420 covers a region corresponding to the lightguide member 600. However, the light-reflective sheet 420 cannot block off the connection between the light-emitting members 700 and the circuit board 700. Therefore, the light-reflective sheet 420 is hollowed out in positions corresponding to the light source slots 510. Similar to the light-blocking sheet 410, the light-reflective sheet 420 also does not cover the fixing members 430. In some embodiments, the side surface of the lightguide member 600 may also be provided with the light-reflective sheet 420 to further enhance an upward emission of the lightguide member 600.

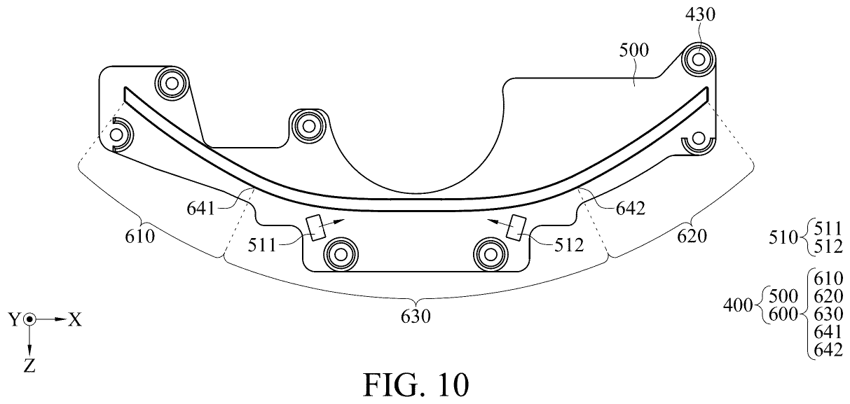

Please refer to FIG. 10. FIG. 10 illustrates a top view of the base plate 500 and the lightguide member 600 of the lightguide assembly 400 according to an embodiment of the instant disclosure. In some embodiments, the base plate 500 merely has two light source slots 510 (i.e., the electronic device 100 merely has two light-emitting members 700). In this embodiment, the two light source slots 510 are adjacent to the connection region 630, one of the light source slots 510 is closer to the first connecting portion 641 and faces a region corresponding to the second extension portion 620 (i.e., the second extension region 522 in FIG. 7), and the other one of the light source slots 510 is closer to the second connecting portion 642 and faces a region corresponding to the first extension portion 610 (i.e., the first extension region 521 in FIG. 7). Specifically, in some embodiments, the two light-emitting members 700 emit interlaced light beams, so that a region in the projection region 520 corresponding to the connection portion 630 (i.e., the connection region 523 in FIG. 7) receives more optical energy than the other regions. Therefore, this embodiment can achieve similar visual effect of the electronic device 100 under the condition of fewer light-emitting members 700 used.

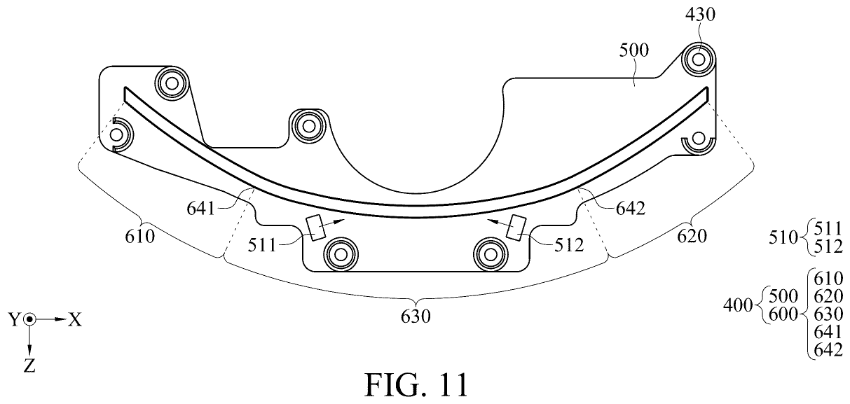

Please refer to FIG. 11. FIG. 11 illustrates a top view of the base plate 500 and the lightguide member 600 of the lightguide assembly 400 according to an embodiment of the instant disclosure. In some embodiments, the connection portion 630 of the lightguide member 600 is a continuous arced section. Consequently, in such embodiments, the connection region 523 formed in the base plate 500 by the connection portion 630 of the lightguide member 600 is also a continuous arced section (not shown in drawings). Such shape of the lightguide member 600 may also be combined with the different configuration methods of the light-emitting members 700 in each of the previously described embodiments to still achieve a uniform and brighter (such as gradually brighter) or dimmer (such as gradually dimmer) visual effect.

As above, the lightguide assembly provided by one or some embodiments of the instant disclosure uses fewer side emitting light sources, and the light sources are arranged outside of the light-exiting area. One or some embodiments of the instant disclosure utilizes the distribution densities of the reflective microstructures to achieve a uniform and brighter (such as gradually brighter) or dimmer (such as gradually dimmer) visual effect. Besides, the lightguide assembly of one or some embodiments of the instant disclosure does not contain diffusion agent, and therefore the light loss is less, and consumption of electrical power can be reduced.

What is claimed is:

1. An electronic device comprising:
a housing having a strip-shaped light-transmissive portion;
a circuit board disposed in the housing; and
a lightguide assembly comprising:
a base plate having a plurality of reflective microstructures;
a lightguide member disposed on the base plate and corresponding to the strip-shaped light-transmissive portion, wherein the lightguide member has a connection portion, a first extension portion, and a second extension portion, the connection portion is connected to the first extension portion at a first connecting portion and connected to the second extension portion at a second connecting portion, the base plate has a connection region, a first extension region, and a second extension region, the connection region, the first extension region, and the second extension region respectively correspond to the connection portion, the first extension portion, and the second extension portion, the reflective microstructures are distributed in the first extension region with a first average density, the reflective microstructures are distributed in the second extension region with a second average density, the reflective microstructures are distributed in the connection region with a third average density, the third average density is greater than the first average density, and the third average density is greater than the second average density; and
a plurality of light-emitting members electrically connected to the circuit board and adjacent to the connection portion, wherein an emitting direction of a portion of the light-emitting members is toward the first extension region, and an emitting direction of another portion of the light-emitting members is toward the second extension region.

2. The electronic device according to claim 1, wherein the light-emitting members comprises:
a first light-emitting member adjacent to the first connecting portion and facing the first extension region;
a second light-emitting member adjacent to the second connecting portion and facing the second extension region;
a third light-emitting member adjacent to the first connecting portion and facing the connection region;
a fourth light-emitting member adjacent to the second connecting portion and facing the connection region.

3. The electronic device according to claim 2, wherein the first light-emitting member has a first emitting main axis, the first extension region has a long axis, an angle between the first emitting main axis and the long axis is between 0° and 25°, the third light-emitting member has a third emitting main axis, and the connection region has a middle section axis, an angle between the third emitting main axis and the middle section axis is between 15° and 30°.

4. The electronic device according to claim 2, wherein the connection region comprises a first arc portion, a second arc portion, and a middle section, the first arc portion is connected to the first extension portion at the first connecting portion, the second arc portion is connected to the second extension portion at the second connecting portion, the middle section is connected between the first arc portion and the second arc portion, a portion of the light-emitting members is adjacent to the first arc portion, and another portion of the light-emitting members is adjacent to the second arc portion.

5. The electronic device according to claim 1, wherein the light-emitting members comprises:
a first light-emitting member adjacent to the first connecting portion and facing the first extension region; and
a second light-emitting member adjacent to the second connecting portion and facing the second extension region.

6. The electronic device according to claim 5, wherein the first light-emitting member has a first emitting main axis, the first extension region has a long axis, and an angle between the first emitting main axis and the long axis is between 0° and 25°.

7. The electronic device according to claim 5, wherein the connection region comprises a first arc portion, a second arc portion, and a middle section, the first arc portion is connected to the first extension portion at the first connecting portion, the second arc portion is connected to the second extension portion at the second connecting portion, the middle section is connected between the first arc portion and the second arc portion, a portion of the light-emitting members is adjacent to the first arc portion, and another portion of the light-emitting members is adjacent to the second arc portion.

8. The electronic device according to claim 1, wherein the first extension region has a free end away from the connection region, and a distribution density of the reflective microstructures in the first extension region decreases from the connection region to the free end of the first extension region.

9. The electronic device according to claim 1, further comprising a light-blocking sheet, wherein the light-blocking sheet is between the base plate and the housing, the light-blocking sheet has a gap, and the lightguide member is arranged to pass through the gap.

10. The electronic device according to claim 9, wherein the housing comprises an upper housing and a lower housing, the strip-shaped light-transmissive portion is disposed on the upper housing, and the light-blocking sheet is between the base plate and the upper housing.

11. The electronic device according to claim 1, further comprising a light-reflective sheet, wherein the light-reflective sheet is between the base plate and the circuit board.

12. A lightguide assembly comprising:
a base plate having a plurality of reflective microstructures;
a lightguide member disposed on the base plate and having a connection portion, a first extension portion, and a second extension portion, the connection portion is connected to the first extension portion at a first connecting portion and connected to the second extension portion at a second connecting portion, the base plate has a connection region, a first extension region, and a second extension region, the connection region, the first extension region, and the second extension region respectively correspond to the connection portion, the first extension portion, and the second extension portion, the reflective microstructures are distributed in the first extension region with a first average density, the reflective microstructures are distributed in the second extension region with a second average density, the reflective microstructures are distributed in the connection region with a third average density, the third average density is greater than the first average density, and the third average density is greater than the second average density; and
a plurality of light-emitting members adjacent to the connection portion, wherein an emitting direction of a portion of the light-emitting members is toward the first extension region, and an emitting direction of another portion of the light-emitting members is toward the second extension region.

13. The lightguide assembly according to claim 12, further comprising:
a first light-emitting member adjacent to the first connecting portion and facing the first extension region;
a second light-emitting member adjacent to the second connecting portion and facing the second extension region;
a third light-emitting member adjacent to the first connecting portion and facing the connection region;
a fourth light-emitting member adjacent to the second connecting portion and facing the connection region.

14. The lightguide assembly according to claim 13, wherein the first light-emitting member has a first emitting main axis, the first extension region has a long axis, an angle between the first emitting main axis and the long axis is between 0° and 25°, the third light-emitting member has a third emitting main axis, the connection region has a middle section axis, and an angle between the third emitting main axis and the middle section axis is between 15° and 30°.

15. The lightguide assembly according to claim 13, wherein the connection region comprises a first arc portion, a second arc portion, and a middle section, the first arc portion is connected to the first extension portion at the first connecting portion, the second arc portion is connected to the second extension portion at the second connecting portion, the middle section is connected between the first arc portion and the second arc portion, a portion of the light-emitting members is adjacent to the first arc portion, and another portion of the light-emitting members is adjacent to the second arc portion.

16. The lightguide assembly according to claim 12, wherein the light-emitting members comprises:
a first light-emitting member adjacent to the first connecting portion and facing the first extension region; and
a second light-emitting member adjacent to the second connecting portion and facing the second extension region.

17. The lightguide assembly according to claim 16, wherein the first light-emitting member has a first emitting main axis, the first extension region has a long axis, and an angle between the first emitting main axis and the long axis is between 0° and 25°.

18. The lightguide assembly according to claim 16, wherein the connection region comprises a first arc portion, a second arc portion, and a middle section, the first arc portion is connected to the first extension portion at the first connecting portion, the second arc portion is connected to the second extension portion at the second connecting portion, the middle section is connected between the first arc portion and the second arc portion, a portion of the light-emitting members is adjacent to the first arc portion, and another portion of the light-emitting members is adjacent to the second arc portion.

19. The lightguide assembly according to claim 12, wherein the first extension region has a free end away from the connection region, and a distribution density of the reflective microstructures in the first extension region decreases from the connection region to the free end of the first extension region.

20. The lightguide assembly according to claim 12, further comprising a light-blocking sheet and a light-reflective sheet, wherein the base plate has a first surface and a second surface, the first surface and the second surface are opposite to each other, the lightguide member is disposed on the first surface, the light-blocking sheet is disposed on the first surface, the light-blocking sheet has a gap, lightguide member is arranged to pass through the gap, and the light-reflective sheet is disposed on the second surface.
